(19) United States
(12) Patent Application Publication
(10) Pub. No.: US 2005/0104986 A1
(43) Pub. Date: May 19, 2005

(54) Low energy consumption imager through operation technique

(76) Inventor: Clay A. Dunsmore, Garland, TX (US)

Correspondence Address: Pamela R. Crocker;Patent Legal Staff, Eastman Kodak Company, 343 State Street, Rochester, NY, 14650-2201, US

(21) Appl. No.: 10/951,234

(22) Filed: Sep. 27, 2004

Related U.S. Application Data
(63) Continuation-in-part of application No. 10/677,766, filed on Oct. 2, 2003.

(51) Int. Cl. H04N 5/335

(52) U.S. Cl. 348/308

(57) ABSTRACT

A CMOS image sensor includes a plurality of pixels each having a photo-sensitive element that receives light that is converted into charge and conversion circuitry that converts the charge into a voltage signal; wherein the plurality of pixels are integrated at substantially a same time; and readout electronics that receives the voltage signal from the conversion circuitry of the plurality of pixels and passes the charge therefrom; wherein the readout electronics are de-energized during substantial integration of the pixels and energized during readout.

### CROSS-REFERENCE TO RELATED APPLICATIONS

This is a continuation-in-part of application Ser. No. 10/677,766, filed Oct. 2, 2003 entitled LOW ENERGY CONSUMPTION IMAGER THROUGH OPERATION TECHNIQUE, by Clay A. Dunsmore.

### FIELD OF THE INVENTION

The invention relates generally to the field of CMOS image sensors and, more particularly, to such CMOS image sensors having reduced energy consumption by de-energizing the read-out electronics of the sensor during integration (non-readout time periods).

### BACKGROUND OF THE INVENTION

CMOS image sensors typically include a plurality of pixels each having a photodiode for capturing incident light and adjacent electronics for receiving charge from the photodiode and converting it into a voltage signal, which is subsequently readout. CMOS sensors are integrated by two methods. In one method, “rolling shutter” method, predetermined rows of the sensor are integrated at different, yet sequential, times. For example, the top first two rows are integrated and then the next two rows are integrated and etc. In the “global shuttering method,” all the rows are integrated at substantially the same time.

Although the above-described methods and apparatus are satisfactory, they include a drawback. In this regard, the horizontal readout electronics, which receives the voltage signals from the rows of pixels, are continuously on so that power is continuously consumed.

Consequently, a need exists for overcoming the above-described drawback of continuous power consumption.

### SUMMARY OF THE INVENTION

The present invention is directed to overcoming one or more of the problems set forth above. Briefly summarized, according to one aspect of the present invention, the invention resides in a CMOS image sensor having a plurality of pixels each having a photo-sensitive element that receives light that is converted into charge and conversion circuitry that converts the charge into a voltage signal; wherein the plurality of pixels are integrated at substantially a same time; and readout electronics that receives the voltage signal from the conversion circuitry of the plurality of pixels and passes the signal therefrom; wherein the readout electronics are de-energized during substantial integration of the pixels and energized during readout.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of reducing power consumption by de-energizing the readout electronics during non-readout time periods.

### BRIEF DESCRIPTION OF THE DRAWINGS

FIG. 1 is a top view of a CMOS image sensor having a plurality of pixels;

FIG. 2 is a schematic diagram of an individual pixel; and

FIG. 3 is a perspective view of a digital camera for implementing a commercial embodiment of the image sensor of FIG. 1.

### DETAILED DESCRIPTION OF THE INVENTION

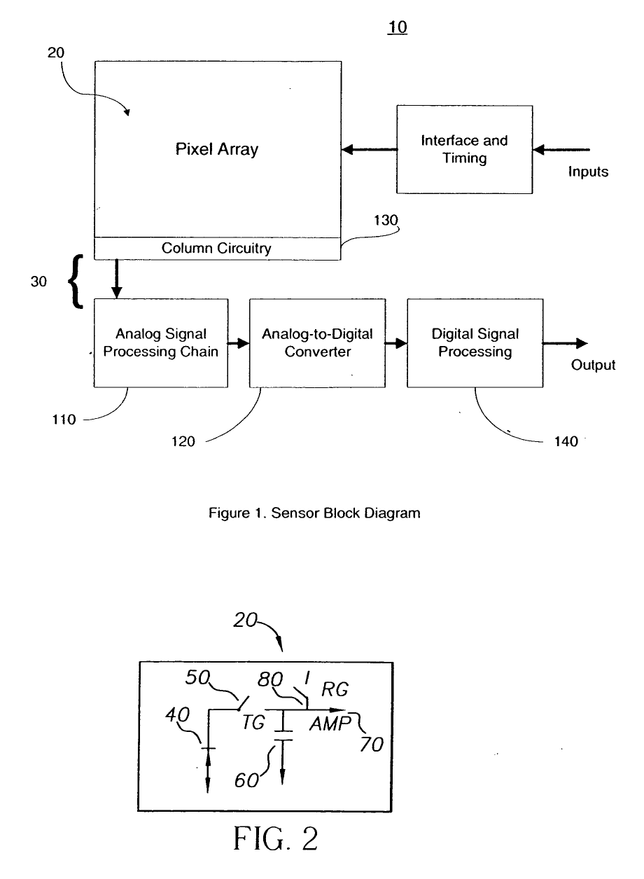

Referring to FIG. 1, there is shown a top view of a CMOS image sensor 10 of the present invention. The sensor 10 includes a plurality of pixels 20 for forming an electronic representation of an image and readout electronics 30 that receives a voltage signal from the plurality of pixels 20. The readout electronics 30 typically consist of column circuits 130 such as sample and hold circuits, and analog signal processing circuits 110 such as buffer amplifiers. These circuits are well known for CMOS image sensors. The readout electronics 30 then typically passes the signal serially to image processing electronics such as analog-to-digital converter 120, and digital signal processing 140 for subsequent processing.

The sensor 10 of the present invention includes global shuttering so that all the pixels 20 are exposed substantially simultaneously. Global shuttering can be performed by any of a variety of well-known mechanisms, as is well known in the art. In this regard, and referring briefly to FIG. 2, each pixel 20 includes a photodiode 40 for capturing incident light that is converted into a charge. It is reiterated for clarity of understanding that the capturing of charge or integration time is substantially the same (global shuttering or non-rolling shuttering) for all the pixels 20. A transfer gate (TG) 50 is then closed for selectively transferring the charge to a capacitor 60. The charge on the capacitor 60 is then selectively passed to an amplifier 70, which converts the charge into a voltage signal. After readout, a reset transistor 80 resets the charge on the capacitor 60 to a predetermined level.

Referring back to FIG. 1, the readout electronics 30 is selectively energized for receiving the signal from the pixels 20. During integration or exposure to light, the readout electronics 30 is de-energized for conserving power, and after integration and during read out, the readout electronics 30 is energized for receiving the voltage signal from the pixels in a row-by-row manner. For example, the first row is read out and then the second row is read out and etc. In addition, the analog-to-digital converter 120, and the digital signal processing 140 may also be de-energized during integration for conserving power. After integration and during read out, the analog-to-digital converter 120, and the digital signal processing 140 are energized for receiving the signal from the readout circuitry.

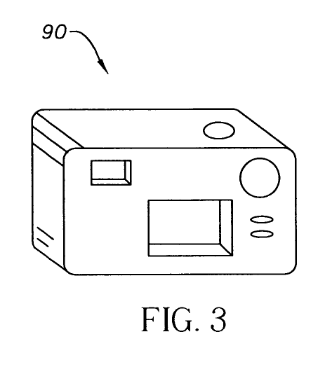

Referring to FIG. 3, there is shown a digital camera 90 for implementing a commercial embodiment of the present invention to which an ordinary consumer is accustomed.

The invention has been described with reference to a preferred embodiment. However, it will be appreciated that variations and modifications can be effected by a person of ordinary skill in the art without departing from the scope of the invention.

### Parts List

10 CMOS image sensor
20 pixels
30 readout electronics
40 photodiode
50 transfer gate
60 capacitor
70 amplifier
80 reset gate
90 digital camera
110 analog signal processing
120 analog-to-digital converter
130 column circuits
140 digital signal processing

1. A CMOS image sensor comprising:
(a) a plurality of pixels each having a photo-sensitive element that receives light that is converted into charge and conversion circuitry that converts the charge into a voltage signal; wherein the plurality of pixels are integrated at substantially a same time;
(b) readout electronics that receives the voltage signal from the conversion circuitry of the plurality of pixels and passes the signal therefrom; wherein the readout electronics are de-energized during substantial integration of the pixels and energized during readout.

2. The CMOS image sensor as in claim 1, wherein the readout electronics consist of column circuits or analog signal processing circuits.

3. A digital camera comprising:
(a) a CMOS image sensor comprising:
(a1) a plurality of pixels each having a photo-sensitive element that receives light that is converted into charge and conversion circuitry that converts the charge into a voltage signal; wherein the plurality of pixels are integrated at substantially a same time;
(a2) readout electronics that receives the voltage signal from the conversion circuitry of the plurality of pixels and passes the charge therefrom; wherein the readout electronics are de-energized during substantial integration of the pixels and energized during readout.

4. The digital camera as in claim 3, wherein the readout electronics consist of column circuits or analog signal processing circuits.
